(19) United States
(12) Patent Application Publication
(10) Pub. No.: US 2008/0138273 A1
(43) Pub. Date: Jun. 12, 2008

(54) Wall flow reactor for hydrogen production

(76) Inventor: Yi Jiang, Horseheads, NY (US)

Correspondence Address: CORNING INCORPORATED, SP-TI-3-1, CORNING, NY, 14831, US

(21) Appl. No.: 11/636,936

(22) Filed: Dec. 11, 2006

(51) Int. Cl. C01B 3/02; B01J 16/00

(52) U.S. Cl. 423/645; 422/197

(57) ABSTRACT

Disclosed herein are wall flow reactors that are suitable for the production of hydrogen gas from hydrocarbon and/or its derivative feed streams. The wall flow reactors are generally comprised a monolithic honeycomb substrate defining a plurality of cell channels bounded by porous channel walls that extend longitudinally from an upstream inlet end to a downstream outlet end; wherein a first portion of the plurality of cell channels are plugged at the downstream outlet end to form inlet cell channels and a second portion of the plurality of cell channels are plugged at the upstream inlet end to form outlet cell channels. A plurality of catalyst layers are positioned within at least a portion of the plurality of cell channels and comprise at least a first catalyst layer and a second catalyst layer. Also disclosed are methods for treating reactant feed streams.

### BACKGROUND OF THE INVENTION

1. Field of the Invention

The present invention relates to a process and apparatus for the production of hydrogen gas from a hydrocarbon and/or its derivative feed streams.

2. Technical Background

Much interest has recently been directed to hydrogen gas (H₂) as U.S. Administration's future fuel of choice. In particular, hydrogen fuel is now required for use in many energy related processes. For example, hydrogen fuel cells represent an exemplary energy related application that has received increased attention in recent years as a possible substitute for energy dependency on gasoline and related non-renewable fossil fuels. To this end, hydrogen can for example be produced by cracking natural gas. However, the expense associated with this process is typically up to four times more expensive than the cost of gasoline. Therefore, to make H₂ a more widely available commodity, it is necessary to develop more efficient high-throughput H₂ production process with competitive production cost to meet this need.

Conventionally, H₂ has been produced by a number of processes including catalytic complete oxidation or catalytic partial process (CPO), in which oxygen-contained gas such as air mostly or pure oxygen is catalytically combined with fuel such as hydrocarbon and/or its derivatives—methanol, ethanol, di(methyl)ester; steam reforming (SR), which combines fuel with steam; or auto thermal reforming (ATR), a combination of catalytic oxidation and steam reforming. From an energy perspective, the fuel complete or partial combustion is an exothermic reaction process whereas the steam reforming is endothermic reaction process. Effectively coupling those two reaction processes can improve the energy efficiency and production cost of the whole process.

The water gas shift (WGS) reaction is another important step in H₂ production and is sometimes conducted in separate, high-temperature- and low-temperature-shift steps, in which CO is reacted with water (steam) to produce H₂ and CO₂, reducing CO below 1%. Conventional WGS processes have utilized Cu—Zn WGS catalysts with typical gas-hour space velocities below 4,000/hr, which in turn require very large reactor volumes.

It has also been shown that the methane catalytic partial oxidation (CPO) can be carried out at few milliseconds contact time scale with platinum or rhodium catalyst deposited on a foamed ZrO₂ or Al₂O₃ monolith or on a granular ZrO₂ and Al₂O₃ supports. To that end, a high yield synthesis gas, i.e., a mixture of CO and H₂, could be generated by this so-called “short-contact time reactor”. By adding steam to the reactant system in short-contact time reactors, one can increase the ratio of H₂ and CO in the product stream and lower the maximum temperature inside reactors.

Coupling these endothermic and exothermic reactions is very difficult using conventional granular type catalyst fixed-beds as it is very difficult to maintain staged thin layers of catalysts position-fixed all time. In particular, at high gas superficial velocity (high-throughput) and during start-up and shut-down period, those thin granular layers of small catalyst particles tend to move due to the “local” particle fluidization phenomena. Such local particle move often leads to the mixing of different layer of catalyst, which is not desire for high yield process due to mixed catalyst functionalities. Similarly, use of the foam monoliths described above makes it very difficult to machine the bulk monolith into a very short monolith layer (few millimeters to few center meters), especially when the diameter of the monolith is relatively large Further, it is also challenging to make an active catalyst deposition on a “pan-cake” shaped foam monolith uniform.

With respect to catalyst and reactor scale up, it is also quite challenging to manufacture a relatively large diameter reactor (e.g., D˜1.0 m) with multiple layers of different catalysts (layer thickness˜few cm) and with very short reactor length. In particular, one cannot simply increase the layer thickness because of the limitation of the total pressure-drop especially when the small granular catalysts are used. Thus, to make the entry flow a uniform distribution is another challenge especially for such a large diameter pan-cake shaped reactor. Still further, adding too many inert layers for better flow distribution often ends up with high pressure-drop increase. Because of the limitation of big reactor diameter and limitation of using thick packing layers, one has to increase the number of “pan-cake” type reactors to meet certain productivity needs, which will increase both capital and operational costs of the process.

In order to lower the capital and operational costs of high-throughout H₂ production, there is a need in the art for a process and apparatus that enables the use of relatively short-contact time reactor features with no limitation of pressure-drop, and no limitation of reactor length and diameter, and which can exhibit improved tolerance to reactor scale up and improved design and operational safety features.

### SUMMARY OF THE INVENTION

The present invention provides a wall flow reactor which enables the staging of multiple thin catalyst layers in a manner that at least substantially eliminates the problems associated with conventional devices and processes described above. For example, by staging the multiple thin washcoat layers on a porous monolithic honeycomb substrate walls, it is possible to internally couple exothermic and endothermic reaction in such a way that the exothermic methane oxidation occurs on the one catalyst layer with CO, CO₂ and H₂O produced as main products. Those products, together with excess methane passing to the second catalyst layer which has desired endothermic methane reforming function, can result in a relatively high ratio of H₂ and CO production. If desired, these H₂-rich product streams can further pass in contact with a Water-Gas-Shift catalyst layer to maximize even more H₂ production and even lower the CO content. One can pursue this embodiment by sequentially staging multiple thin layer washcoat catalysts.

In one embodiment, the wall flow reactor of the present invention can provide a sequential staging of multiple washcoat catalyst layers in such a way that there is at least substantially no possibility of different catalyst mixing since the active catalytic components (e.g., precious metal) are fixed inside washcoat. Still further, the reactor can be scaled up in both diameter and reactor length without causing high pressure-drop and flow maldistribution since the pressure-drop is no longer dependent on the diameter and is at least less dependent on the length of the wall flow reactor of the present invention.

Accordingly, in one embodiment, the present invention provides a catalytic wall flow reactor comprising a monolithic honeycomb substrate defining a plurality of cell channels bounded by porous channel walls that extend longitudinally from an upstream inlet end to a downstream outlet end. A first portion of the plurality of cell channels are plugged at the downstream outlet end to form inlet cell channels and a second portion of the plurality of cell channels are plugged at the upstream inlet end to form outlet cell channels. A fluid stream passing through the cells of the honeycomb substrate from the inlet end to the outlet end flows into at least a portion of the inlet cell channels, through at least a portion of the porous channel walls, and out of the outlet cell channels. A plurality of catalyst layers positioned within at least a portion of the plurality of cell channels and comprise at least a first catalyst layer and a second catalyst layer. The wall flow rector further comprises a means for sequentially communicating the fluid stream with at least the first and second catalyst layers of the plurality of catalyst layers.

In use, the wall flow reactor of the present invention further provides a method for treating a reactant feed stream. In one embodiment, the method can generally comprise providing a monolithic honeycomb substrate as described herein. A reactant feed stream can be passed through at least a portion of the upstream cell channel inlet openings and into at least a portion of the inlet cell channels. The reactant feed stream contacts at least the first catalyst layer to provide a first treated reactant stream, after which the first treated reactant stream can contact the second catalyst layer to provide a second treated reactant stream. The second treated reactant stream can then be passed through the downstream outlet cell channel openings for any desired subsequent downstream processing.

Among several advantages that can be exhibited by the devices and methods of the instant invention is reactant flow having a substantially uniform flow path through a washcoat substrate wall layers. Even at high superficial gas velocity (high-throughput), the pressure-drop of reactor is still lower comparing with those conventional granular and foam catalyst beds. Further, by controlling substrate channel wall thickness and the permeability of the channel walls, one can control or optimize flow residence time and the pressure-drop through the channel walls. In one embodiment, the permeability of the channel walls can be controlled or optimized by providing channel walls having desired pore microstructures. In still another embodiment, there is substantially no internal diffusion limit due to the thin washcoat catalyst layers. Additionally, the wall flow reactor can be scaled up without limitation to increase productivity per reactor. For example, the reactor can be scaled up by increasing the reactor diameter and/or the reactor length without changing the channel scale transport and reaction features.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 illustrates an exemplary wall flow reactor substrate according to one embodiment of the present invention.

FIG. 2a illustrates a wall flow reactor comprising an exemplary configuration of a first and second catalyst layers according to one embodiment of the present invention.

FIG. 2b illustrates a wall flow reactor comprising an exemplary configuration of a first and second catalyst layers according to one embodiment of the present invention.

FIG. 3 illustrates an exemplary sequential staging of two wall flow reactors according to one embodiment of the present invention.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a catalyst includes embodiments having two or more such catalysts unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, is based on the total weight of the composition or article in which the component is included.

As briefly summarized above, in one embodiment the present invention provides a catalytic wall flow reactor that is capable of producing hydrogen gas from a hydrocarbon feedstock. The structure of the wall flow reactor enables a plurality of catalyst layers to be staged in a manner that at least substantially prevents any mixing or interaction between the plurality of catalyst layers during various stages of use, including start up, shut down, and even during conditions of relatively high gas superficial velocity. Thus, the wall flow reactors of the present invention can also provide a substantially uniform flow path for a reactant feed stream. The substantially uniform flow path can still further enable a reactor of the present invention to operate at relatively high superficial gas velocities without exhibiting significant levels or pressure drop across the total reactor length (L).

The wall flow reactor can be formed from a monolithic honeycomb substrate. The monolithic honeycomb substrate generally defines a plurality of cell channels bounded by porous channel walls that extend longitudinally from an upstream inlet end to a downstream outlet end. A first portion of the plurality of cell channels are plugged at the downstream outlet end to form inlet cell channels and a second portion of the plurality of cell channels are plugged at the upstream inlet end to form outlet cell channels. During use, a fluid stream passing through the cells of the honeycomb substrate from the inlet end to the outlet end flows into at least a portion of the inlet cell channels, through at least a portion of the porous channel walls, and out of the outlet cell channels.

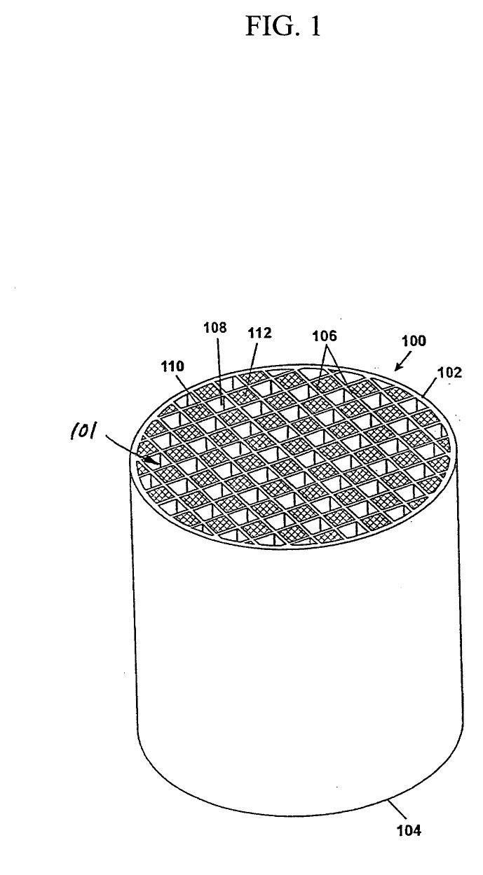

With reference to FIG. 1, an exemplary wall flow reactor 100 is shown. As illustrated, the reactor 100 preferably has an upstream inlet end 102 and a downstream outlet end 104, and a multiplicity of cells 108 (inlet), 110 (outlet) extending longitudinally from the inlet end to the outlet end. The multiplicity of cells is formed from intersecting porous cell walls 106. A first portion of the plurality of cell channels are plugged with end plugs 112 at the downstream outlet end (not shown) to form inlet cell channels and a second portion of the plurality of cell channels are plugged at the upstream inlet end with end plugs 112 to form outlet cell channels. The exemplified plugging configuration forms alternating inlet and outlet channels such that a fluid stream flowing into the reactor through the open cells at the inlet end 102, then through the porous cell walls 106, and out of the reactor through the open cells at the outlet end 104. The exemplified end plugged cell configuration can be referred to herein as a “wall flow” configuration since the flow paths resulting from alternate channel plugging direct a fluid stream being treated to flow through the porous ceramic cell walls prior to exiting the filter.

The honeycomb substrate can be formed from any conventional material suitable for forming a porous monolithic honeycomb body. For example, in one embodiment, the substrate can be formed from a sintered phase ceramic composition. Exemplary sintered phase ceramic compositions can include cordierite, aluminum titanate, silica carbide, aluminum oxide, zirconium oxide, zirconia, magnesium, stabilized zirconia, zirconia stabilized alumina, yttrium stabilized zirconia, calcium stabilized zirconia, alumina, magnesium stabilized alumina, calcium stabilized alumina, titania, silica, magnesia, niobia, ceria, vanadia, nitride, carbide, or any combination thereof. Alternatively, in another embodiment the monolithic substrate material can be formed from one or more metallic material.

The honeycomb substrate can be formed according to any conventional process suitable for forming honeycomb monolith bodies. For example, in one embodiment a plasticized ceramic forming batch composition can be shaped into a green body by any known conventional ceramic forming process, such as, e.g., extrusion, injection molding, slip casting, centrifugal casting, pressure casting, dry pressing, and the like. Typically, a ceramic precursor batch composition comprises inorganic ceramic forming batch component(s) capable of forming, for example, one or more of the sintered phase ceramic compositions set forth above, a liquid vehicle, a binder, and one or more optional processing aids and additives including, for example, lubricants, and/or a pore former.

In an exemplary embodiment, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die. The formed green body can then be dried and fired under conditions effective to convert the green body into a sintered phase ceramic composition.

It should be understood that one of ordinary skill in the art will be able to determine and optimize a desired ceramic forming batch composition suitable for forming a particularly desired sintered phase composition without requiring any undue experimentation. Similarly, the optimum firing schedule for converting a formed green body into a sintered phase ceramic composition will also be readily obtainable by one of ordinary skill in the art and, as such, the details of particular firing schedules will not be discussed herein. However, in an exemplary embodiment, the inorganic batch components can be any combination of inorganic components which, upon firing, can provide a primary sintered phase composition. In one aspect, the inorganic batch components can be selected from a magnesium oxide source; an alumina-forming source; and a silica source. Still further, the batch components can be selected so as to yield a ceramic article comprising cordierite, mullite, spinel, aluminum titanate, or a mixture thereof upon firing. For example, and without limitation, in one aspect, the inorganic batch components can be selected to provide a cordierite composition consisting essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch composition preferably comprises about 33 to about 41 weight percent aluminum oxide source, about 46 to about 53 weight percent of a silica source, and about 11 to about 17 weight percent of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,24,437; 6,210,626; 5,183,608; 5,258,150; 6,432,856; 6,773,657; 6,864,198; and U.S. patent application Publication Nos.: 2004/0029707; 2004/0261384.

Alternatively, in another aspect, the inorganic batch components can be selected to provide mullite composition consisting essentially of, as characterized in an oxide weight percent basis, from 27 to 30 percent by weight SiO₂, and from about 68 to 72 percent by weight Al₂O₃. An exemplary inorganic mullite precursor powder batch composition can comprise approximately 76% mullite refractory aggregate; approximately 9.0% fine clay; and approximately 15% alpha alumina. Additional exemplary non-limiting inorganic batch component mixtures suitable for forming mullite include those disclosed in U.S. Pat. Nos. 6,254,822 and 6,238,618.

Still further, the inorganic batch components can be selected to provide alumina titanate composition consisting essentially of, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. patent application Publication Nos.: 2004/0020846; 2004/0092381; and in PCT Application Publication Nos.: WO 2006/015240; WO 2005/046840; and WO 2004/011386.

The inorganic ceramic batch components can also be synthetically produced materials such as oxides, hydroxides, and the like. Alternatively, they can be naturally occurring minerals such as clays, talcs, or any combination thereof. Thus, it should be understood that the present invention is not limited to any particular types of powders or raw materials, as such can be selected depending on the properties desired in the final ceramic body.

The formed monolithic honeycomb can have any desired cell density. For example, the exemplary monolith 100 may have a cellular density from about 70 cells/in² (10.9 cells/cm²) to about 400 cells/in² (62 cells/cm²). Still further, as described above, a portion of the cells 10 at the inlet end 102 are plugged with a paste having the same or similar composition to that of the body 101. The plugging is preferably performed only at the ends of the cells and form plugs 112 typically having a depth of about 5 to 20 mm, although this can vary. A portion of the cells on the outlet end 104 but not corresponding to those on the inlet end 102 may also be plugged in a similar pattern. Therefore, each cell is preferably plugged only at one end. The preferred arrangement is to therefore have every other cell on a given face plugged as in a checkered pattern as shown in FIG. 1. Further, the inlet and outlet channels can be any desired shape. However, in the exemplified embodiment shown in FIG. 1, the cell channels are typically square shape.

In one aspect, the ceramic articles of the instant invention comprise a relatively high level of total porosity. For example, the ceramic articles of the instant invention can comprise a total porosity, % P, greater than 30%.

The ceramic bodies of the present invention can also comprise a relatively narrow pore size distribution evidenced by a minimized percentage of relatively fine and/or relatively large pore sizes. To this end, relative pore size distributions can be expressed by a pore fraction which, as used herein, is the percent by volume of porosity, as measured by mercury porosimetry, divided by 100. For example, the quantity d₅₀ is the median pore size based upon pore volume, and is measured in micrometers; thus, d₅₀ is the pore diameter at which 50% of the open porosity of the ceramic has been intruded by mercury. The quantity d₉₀ is the pore diameter at which 90% of the pore volume is comprised of pores whose diameters are smaller than the value of d₉₀; thus, d₉₀ is also equal to the pore diameter at which 10% by volume of the open porosity of the ceramic has been intruded by mercury. Still further, the quantity d₁₀ is the pore diameter at which 10% of the pore volume is comprised of pores whose diameters are smaller than the value of d₁₀; thus, d₁₀ is equal to the pore diameter at which 90% by volume of the open porosity of the ceramic has been intruded by mercury. The pore fraction d₁₀ can, in one aspect, be less than 1 micron. The pore fraction d₉₀ can, in another aspect, be more than 50 microns.

The median pore diameter, d₅₀, of the pores present in the instant ceramic articles can, in one aspect, be greater than 5 μm, greater than 10 μm, greater than 20 μm, or even greater than 30 μm. In another aspect, the median pore diameter can be in the range of from 5 μm to 40 μm. In still another aspect, the median pored diameter can be in the range of from 10 μm to 30 μm.

As summarized above, in one embodiment, the wall flow reactors of the present invention can provide a reactant flow having a substantially uniform flow path through the washcoat substrate wall layers. Further, even at relatively high superficial gas velocity (high-throughput), the pressure-drop of reactor is still relatively lower than the pressure drop exhibited by conventional granular and foam catalyst beds. Accordingly, in still another embodiment, the channel wall thickness of the honeycomb monolith can be optimized to control flow residence time through the channel walls. For example, in one embodiment the cell channel walls can have a thickness of at least 0.05 mm. Alternatively, the channel wall thickness can be less than 5 mm. Still further, the channel wall thickness can be in the range of from 0.05 mm to 5 mm, including exemplary thicknesses of about 0.10 mm, 0.50 mm, 1.0 mm, 1.5 mm, 2.0 mm, 2.5 mm, 3.0 mm, 3.5 mm, 4.0 mm, 4.5 mm, or a thickness in any range derived from these values.

Both modeling and experimental data have indicated that the total pressure drop across the length of an inventive wall flow reactor is not affected by variations in the diameter of the honeycomb monolith reactor. Therefore, the scale up from a relatively small diameter honeycomb monolith to a larger diameter honeycomb monolith reactor will not change the total pressure drop. In particular, the total pressure-drop across the reactor is a function of four factors, as indicated in Equation (I), as set for the below:

ΔPₜₒₜₐₗ=ΔP_{subs-wall}+ΔP_{channel}+ΔP_{plug}+ΔPᵢₙₗₑₜ₋ₒᵤₜₗₑₜ Equation (I)

In Equation (1), ΔP_{subs-wall}: is a pressure drop factor dependent upon the channel web thickness and channel web microstructure, including such variables as porosity, pore size distribution and pore morphology; ΔP_{channel}: is a pressure drop factor dependent upon channel size, channel superficial velocity and channel surface friction coefficient; ΔP_{plug}: is a pressure drop factor dependent upon the length of plugs used to form the wall flow pattern; and ΔPᵢₙₗₑₜ₋ₒᵤₜₗₑₜ: is a pressure drop factor dependent upon flow contraction energy loss and flow expansion energy loss. None of these terms or factors contributing to the total pressure drop are dependent upon the diameter of the wall flow reactor of present invention. Therefore, once a desired channel superficial velocity (Uch) is achieved for a given reactor having certain cell density, web thickness, plug length, reactor length, and substrate microstructure (including pore size distribution, porosity, pore morphology), the reactor can then be scaled up to any desired diameter without increasing the pressure drop across the reactor.

The wall flow reactor further comprises a plurality of catalyst washcoat layers applied thereon. In particular, at least a first catalyst layer is applied to a first portion of the wall flow reactor and at least a second catalyst layer is applied to a second portion of the wall flow reactor. The at least first and second catalyst layers are fixed and staged in sequence such that at least a portion of a reactant stream passing through the honeycomb substrate interacts with the at least first and second catalyst layers in sequence. By applying multiple fixed thin catalyst layers to the monolithic honeycomb structure, internal diffusion and mixing of catalyst layers is at least substantially eliminated. Further, as summarized above, the fixed nature of the catalyst layers can provide a uniform flow path for a reactant stream. Thus, the reactor can be scaled up to any desired length and diameter without a significant increase in pressure drop or any significant flow path maldistribution. For example, it is contemplated that a wall flow reactor of the present invention can be scaled up to, and without limitation, at least 0.6 meters in diameter. In another embodiment, the wall flow reactor can be scaled up to, and without limitation, at least 1.0 meter in diameter. Still further, in another embodiment, the wall flow reactor can be scaled up to, and without limitation, at least 2.0 meters in diameter. The operational flow rate in a wall flow reactor of the present invention can be designed up to, for example, 1,000,000 (1/hour), or even up to 10,000,000 (1/hour). This gas hourly space velocity (GHSV) is defined as a ratio of the superficial reactant flow rate in volume/hour and the reactor body volume.

In one embodiment, the catalytic wall flow reactor is capable of producing hydrogen from a reactant feed stream comprising at least carbon and hydrogen atoms. Exemplary feed streams comprising at least carbon and hydrogen atoms can include hydrocarbons such as methane, ethane, propane, and liquid hydrocarbon (like diesel). Alternatively, the feed stream can comprise oxygen containing fuel like methanol, ethanol, bio-diesel, and/or biomass.

Exemplary catalyst washcoat layers can comprise one or more of a catalytic partial oxidation (CPO) catalyst, a steam reforming catalyst, and/or a water gas shift catalyst. To that end, exemplary catalytic partial oxidation catalysts include, without limitation, nickel, samarium, rhodium, cobalt, platinum, Ni—MgO, or any one or more of the Group VIII metals. Exemplary steam reforming catalysts can comprise at least a supported metal catalyst, selected from the group consisting of nickel, rhodium, platinum. Still further, exemplary water gas shift catalysts can include, without limitation, Fe₂O₃—Cr₂O₃, CuO—ZnO, CuO—ZnO—Al₂O₃, CuO—CeO₂—Al₂O₃, Re—Pt/CeO₂.

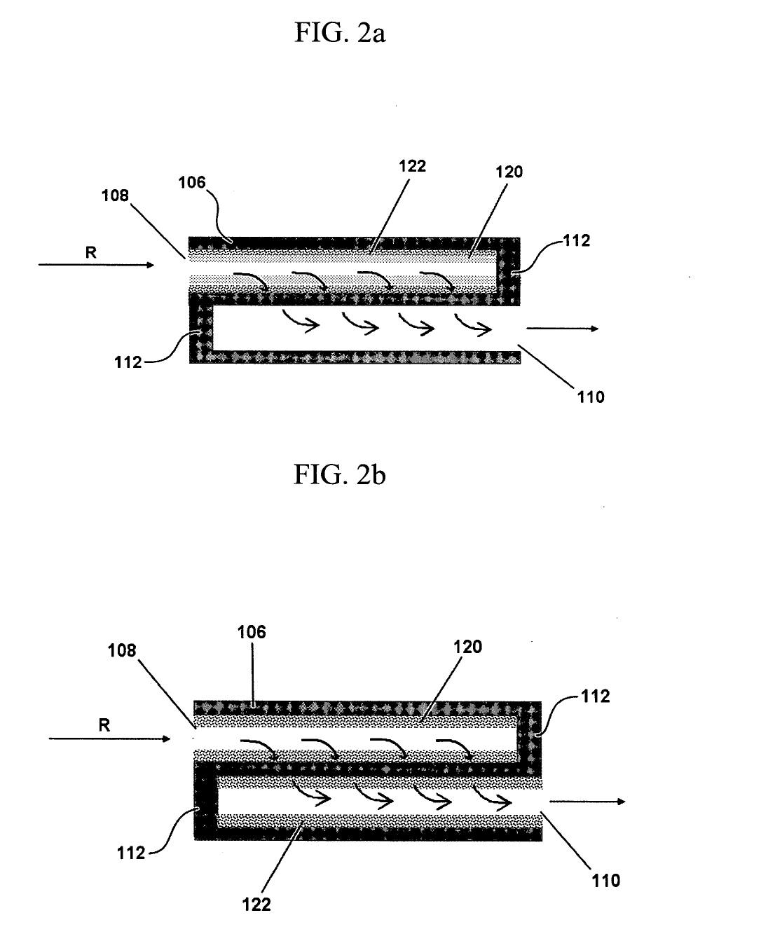

The catalyst layers can be applied to the wall flow reactor in any configuration or sequence. In one embodiment, the first and second catalyst layers are positioned in overlying registration in at least a portion of the inlet or outlet cell channels. For example, in one embodiment as shown in FIG. 2a, a wall flow reactor 100 can comprise a first catalyst layer 120 and second catalyst layer 122 deposited on at least a portion of the channel walls 106 of the inlet cell channel 108. According to this embodiment, the second catalyst 122, such as a steam reforming catalyst can first be applied to the inlet channel to form a steam reforming catalyst layer. The first catalyst layer 120, such as a catalytic partial oxidation catalyst layer, can then be applied to the already deposited steam reforming catalyst layer.

In an alternative embodiment, the first catalyst layer can be positioned on at least a portion of the porous channel walls bounding the inlet cell channels and a second catalyst layer positioned on at least a portion of the porous channel walls bounding the outlet cell channel wall comprise a second catalyst. For example, as shown in FIG. 2b, a first catalyst 120 can be applied to a portion of the inlet cell channel walls 106 of the inlet cell channel 108. A second catalyst 122 can be applied to a portion of the outlet cell channel walls of the outlet cell channel 110. For example, in the exemplified embodiment, a catalytic partial oxidation catalyst layer can be deposited on the cell channel walls of the inlet cells.

Similarly, a steam reforming catalyst can be applied to a portion of the cell outlet channel.

Still further, it should also be understood that the catalyst layer can be applied with varying levels of permeation into the cell channel walls. For example, in one embodiment, the catalyst layer can be applied substantially only on the surface portion of a cell wall. This can be referred to as an “on wall” catalyst loading. Alternatively, an applied catalyst washcoat can at least substantially penetrate the pore micro structure to provide an “in-wall” catalyst washcoat. To this end, it will be appreciated that the catalyst washcoat layers can be applied by any known conventional means. Thus, the details of applying a washcoating are not discussed herein.

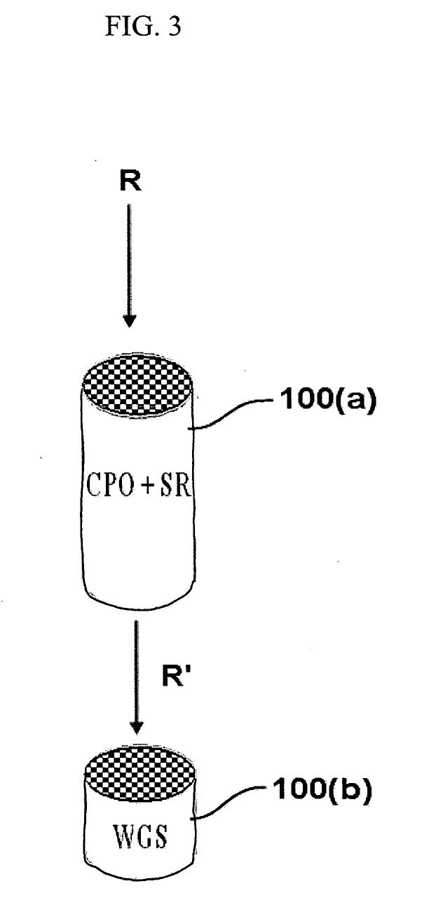

In still another embodiment, a plurality of wall flow reactors can be staged in sequence such that a stream exiting the downstream end of a first wall flow reactor can subsequently pass through a second wall flow reactor of the present invention. Once again, the uniform reactant flow path provided by the present invention can enable any number of wall flow reactors to be staged in sequence with out resulting in any significant increase in pressure drop across the system. For example, as illustrated in FIG. 3, a first upstream wall flow reactor 100(a) can comprise a catalytic partial oxidation catalyst stage in sequence with a steam reforming catalyst. A hydrocarbon reactant feed stream R can pass through the first wall flow reactor to provide a treated reactant feed stream R′ comprising hydrogen, carbon monoxide and water. However, to improve the hydrogen yield from the first reactor, a second wall flow reactor 100(b) can be staged sequentially downstream from the outlet end of the first reactor and can have a plurality of water gas shift catalyst layers deposited thereon. As the stream exiting the upstream reactor enters the second wall flow reactor, in the exemplified embodiment, the carbon monoxide and water can under go the water gas shift reaction to yield additional hydrogen and carbon dioxide.

In use, the wall flow reactors of the present invention further provide methods for treating a reactant feed stream comprising at least hydrogen and carbon atoms. In particular, A reactant feed stream can be passed or otherwise introduced through at least a portion of the upstream cell channel inlet openings and into at least a portion of the inlet cell channels. This reactant feed stream can then be contacted with at least the first catalyst layer to provide a first treated reactant stream. The first reactant stream can then contact the second catalyst layer to provide a second treated reactant stream. The second reactant stream can then be passed through the downstream outlet cell channel openings for any desired subsequent downstream processing.

In one embodiment, the reactant stream can contact the first catalyst layer in at least a portion of the inlet cell channels to provide the first treated reactant stream. According to this embodiment, the first treated reactant stream can sequentially contacts the second catalyst layer in at least a portion of the outlet cell channels. Alternatively, in another embodiment the first treated reactant stream can sequentially contact the second catalyst layer in at least a second portion of the inlet cell channels.

In still another embodiment, the reactant stream can contact the first catalyst layer in at least a portion of the outlet cell channels to provide the first treated reactant stream. According to this embodiment, the first treated reactant stream would also sequentially contacts the second catalyst layer in at least a second portion of the outlet cell channels.

If desired, the optional subsequent downstream processing can further comprise passing the second treated reactant stream through at least a portion of the upstream cell channel inlet openings of a second provided wall flow reactor of the present invention. For example, in one embodiment that second provided wall flow reactor can comprise a water gas shift catalyst combination as described herein.

Lastly, it should be understood that while the present invention has been described in detail with respect to certain illustrative and specific embodiments thereof, it should not be considered limited to such, as numerous modifications are possible without departing from the broad spirit and scope of the present invention as defined in the appended claims. For example, although the invention has been exemplarily described in connection with catalysts and reactant feed streams suitable for hydrogen production, it should also be understood that the principle of this invention is not limited to only hydrogen production and can, for example, be applied to other applications such as synthesis gas production processes.

1. A catalytic wall flow reactor, comprising:
a monolithic honeycomb substrate defining a plurality of cell channels bounded by porous channel walls that extend longitudinally from an upstream inlet end to a downstream outlet end;
wherein a first portion of the plurality of cell channels are plugged at the downstream outlet end to form inlet cell channels and a second portion of the plurality of cell channels are plugged at the upstream inlet end to form outlet cell channels, wherein a fluid reactant stream passing through the cells of the honeycomb substrate from the inlet end to the outlet end flows into at least a portion of the inlet cell channels, through at least a portion of the porous channel walls, and out of the outlet cell channels; and
a plurality of catalyst layers positioned within at least a portion of the plurality of cell channels, wherein the plurality of catalyst comprises at least a first catalyst layer and a second catalyst layer; and
a means for sequentially communicating the fluid stream with at least the first and second catalyst layers of the plurality of catalyst layers.

2. The catalytic wall flow reactor of claim 1, wherein the means for sequentially communicating the fluid stream comprises a first catalyst layer positioned on at least a portion of the porous channel walls bounding the inlet cell channels and a second catalyst layer positioned on at least a portion of the porous channel walls bounding the outlet cell channel wall comprise a second catalyst.

3. The catalytic wall flow reactor of claim 1, wherein the means for sequentially communicating the fluid stream comprises a first and second catalyst layer that are positioned in overlying registration in at least a portion of the inlet or outlet cell channels.

4. The catalytic wall flow reactor of claim 1, wherein the porous ceramic honeycomb substrate body is comprised of a sintered phase ceramic composition.

5. The catalytic wall flow reactor of claim 1, wherein the porous ceramic honeycomb substrate body is comprised of at least one material selected from cordierite, silica carbide, aluminum oxide, and zirconium oxide. wherein the catalyst support comprises zirconia, magnesium, stabilized zirconia, zirconia stabilized alumina, yttrium stabilized zirconia, calcium stabilized zirconia, alimuna, magnesium stabilized alumina, calcium stabilized alumina, cordierite, titania, silica, magnesia, niobia, ceria, vanadia, nitride, carbide, or combination thereof,

6. The catalytic wall flow reactor of claim 1, wherein the substrate is comprised of a metal.

7. The catalytic wall flow reactor of claim 1, wherein the porous substrate walls have a wall thickness in the range of from 0.05 mm to 5 mm.

8. The catalytic wall flow reactor of claim 1, wherein the first catalyst is a hydrocarbon oxidation catalyst.

9. The catalytic wall flow reactor of claim 6, wherein the hydrocarbon partial oxidation catalyst comprises at least one of nickel, samarium, rhodium, cobalt, platinum, Ni—MgO, or Group VIII metals.

10. The catalytic wall flow reactor of claim 7, wherein the catalyst support comprises zirconia, magnesium, stabilized zirconia, zirconia stabilized alumina, yttrium stabilized zirconia, calcium stabilized zirconia, alumina, magnesium stabilized alumina, calcium stabilized alumina, cordierite, titania, silica, magnesia, niobia, ceria, vanadia, nitride, carbide, or combination thereof,

11. The catalytic wall flow reactor of claim 1, wherein the second catalyst is a reforming catalyst.

12. The catalytic wall flow reactor of claim 8, wherein the reforming catalyst is a steam reforming catalyst comprises at least a supported metal catalyst, wherein the metals are one or more selected from the group consisting of nickel, rhodium, platinum.

13. The catalytic wall flow reactor of claim 1, wherein the catalytic wall flow reactor is capable of producing hydrogen from a reactant feed stream consisting of at least carbon and hydrogen atoms.

14. A method for treating a reactant feed stream, comprising the steps of:
providing a monolithic honeycomb substrate defining a plurality of cell channels bounded by porous channel walls that extend longitudinally from an upstream inlet end to a downstream outlet end; wherein a first portion of the plurality of cell channels are plugged at the downstream outlet end to form inlet cell channels having upstream inlet openings and a second portion of the plurality of cell channels are plugged at the upstream inlet end to form outlet cell channels having downstream outlet cell openings; and having a plurality of catalyst layers positioned within at least a portion of the plurality of cell channels, wherein the plurality of catalyst comprises at least a first catalyst layer and a second catalyst layer;
passing a reactant feed stream consisting of at least carbon and hydrogen atoms through at least a portion of the upstream cell channel inlet openings and into at least a portion of the inlet cell channels;
contacting the reactant feed stream with at least the first catalyst layer to provide a first treated reactant stream,
contacting the first treated reactant stream with the second catalyst layer to provide a second treated reactant stream; and
passing the second treated reactant stream consisting of at least carbon and hydrogen atoms through the downstream outlet cell channel openings.

15. The method of claim 14, wherein the reactant stream contacts the first catalyst layer in at least a portion of the inlet cell channels and wherein the first treated reactant stream sequentially contacts the second catalyst layer in at least a portion of the outlet cell channels.

16. The method of claim 14, wherein the reactant stream contacts the first catalyst layer in at least a portion of the inlet cell channels and wherein the first treated reactant stream sequentially contacts the second catalyst layer in at least a portion of the inlet cell channels.

17. The method of claim 14, wherein the porous substrate walls of the provided honeycomb monolith have a wall thickness in the range of from 0.05 mm to 5 mm.

18. The method of claim 14, wherein the first catalyst is a hydrocarbon oxidation catalyst.

19. The method of claim 18, wherein the hydrocarbon oxidation catalyst comprises a methane oxidation catalyst.

20. The method of claim 19, wherein the methane oxidation catalyst comprises at least one of nickel, magnesium, samarium, rhodium, cobalt, platinum, platinum-rhodium, rhodium-samarium, iron, ruthenium, osmium, and hassium.

21. The method of claim 14, wherein the second catalyst is a reforming catalyst.

22. The method of claim 14, wherein the hydrocarbon reactant feed stream comprises methane.

23. The method of claim 14, wherein the first treated hydrocarbon reactant feed stream comprises hydrogen gas and carbon monoxide.

24. The method of claim 14, wherein the second treated hydrocarbon reactant feed stream comprises hydrogen gas and carbon dioxide.

25. The method of claim 14, wherein the reactant feed stream comprises carbon and hydrogen atoms.

26. The method of claim 14, further comprising:
providing a second monolithic honeycomb substrate defining a plurality of cell channels bounded by porous channel walls that extend longitudinally from an upstream inlet end to a downstream outlet end; wherein a first portion of the plurality of cell channels are plugged at the downstream outlet end to form inlet cell channels having upstream inlet openings and a second portion of the plurality of cell channels are plugged at the upstream inlet end to form outlet cell channels having downstream outlet cell openings; and having a plurality of catalyst layers positioned within at least a portion of the plurality of cell channels, wherein the plurality of catalyst comprises at least a first catalyst layer and a second catalyst layer; and
passing the second treated reactant stream through at least a portion of the upstream cell channel inlet openings of the second monolithic honeycomb substrate.

27. The method of claim 26, wherein the plurality of catalyst layers of the second monolithic honeycomb substrate comprise a water gas shift catalyst.
